(19) United States
(12) Patent Application Publication
(10) Pub. No.: US 2025/0267605 A1
(43) Pub. Date: Aug. 21, 2025

(54) METHOD AND APPARATUS FOR PROCESSING CLOCK SKEW, COMPUTER-READABLE MEDIUM, AND ELECTRONIC DEVICE

(71) Applicant: Tencent Technology (Shenzhen) Company Limited, Shenzhen (CN)

(72) Inventors: Yixue LEI, Shenzhen (CN); Yuhang Jia, Shenzhen (CN); Yong Yang, Shenzhen (CN); Yunfei Zhang, Shenzhen (CN)

(21) Appl. No.: 19/199,171

(22) Filed: May 5, 2025

Related U.S. Application Data
(63) Continuation of application No. PCT/CN2024/089433, filed on Apr. 24, 2024.

(30) Foreign Application Priority Data
May 6, 2023 (CN) 202310509056.9

(51) Int. Cl. H04W 56/00

(52) U.S. Cl. CPC H04W 56/004

(57) ABSTRACT

Provided is a method and for processing a clock skew by an electronic device. The method includes: receiving a data packet transmitted from a first device to a second device and then from the second device to the electronic device, the data packet comprising a first timestamp and a second timestamp; acquiring a local timestamp when the electronic device receives the data packet; acquiring, according to the first timestamp, the second timestamp, and the local timestamp, delay information of a specified link part of a transmission link between the electronic device and the first device; acquiring, according to the delay information of the specified link part and a link type of the specified link part, a clock skew corresponding to the specified link part; and performing, according to the clock skew, clock synchronization on a transmission node corresponding to the specified link part.

### CROSS-REFERENCE TO RELATED APPLICATIONS

This application is a continuation application of PCT Patent Application No. PCT/CN2024/089433, entitled “METHOD AND APPARATUS FOR PROCESSING CLOCK SKEW, COMPUTER-READABLE MEDIUM, AND ELECTRONIC DEVICE” filed on Apr. 24, 2024, which claims the benefit of priority to Chinese Patent Application No. 2023105090569, entitled “METHOD AND APPARATUS FOR PROCESSING CLOCK SKEW, COMPUTER-READABLE MEDIUM, AND ELECTRONIC DEVICE” filed with the China National Intellectual Property Administration on May 6, 2023, all of which are incorporated herein by reference in their entirety.

### FIELD OF THE TECHNOLOGY

This application relates to the technical field of computers and communication, and in particular, to a method and apparatus for processing a clock skew, a computer-readable medium, and an electronic device.

### BACKGROUND OF THE DISCLOSURE

As a network technology for time synchronization and deterministic communication between nodes defined by the Institute of Electrical and Electronics Engineers (IEEE), a time sensitive network (TSN) is mainly used for real-time communication and network control. With time sensitive communication (TSC) of the TSN introduced to a 5th generation (5G) system, the 5G system can support application of industrial automated manufacturing with precise time control.

### SUMMARY

An embodiment of this application provides a method for processing a clock skew performed by a third device, and the method includes: receiving a data packet, wherein the data packet is transmitted via a transmission link from a first device to a second device and then from the second device to the electronic device, and the data packet comprising a first timestamp and a second timestamp, wherein the first timestamp is added into the data packet when the first device transmits the data packet, and the second timestamp is added into the data packet when the second device receives the data packet; acquiring a local timestamp when the electronic device receives the data packet; acquiring, according to the first timestamp, the second timestamp, and the local timestamp, delay information of a specified link part of the transmission link between the electronic device and the first device; acquiring, according to the delay information of the specified link part and a link type of the specified link part, a clock skew corresponding to the specified link part; and performing, according to the clock skew, clock synchronization on a transmission node corresponding to the specified link part.

An embodiment of this application provides a non-transitory computer-readable medium. The computer-readable medium has a computer program stored therein, the computer program, when executed by a processor of an electronic device, implementing the method for processing a clock skew described in the above embodiments.

An embodiment of this application provides an electronic device. The electronic device includes: one or more processors; and a memory configured to store one or more computer programs, the one or more computer programs causing the electronic device to implement the method for processing a clock skew described in the above embodiments when executed by the one or more processors.

### BRIEF DESCRIPTION OF THE DRAWINGS

FIG. 1 shows a schematic diagram of an architecture in which a 5th generation (5G) system supports time synchronization of an external time domain;

FIG. 2 shows a schematic diagram of an exemplary system architecture to which technical solutions in embodiments of this application can be applied;

FIG. 3 shows a flowchart of a method for processing a clock skew according to an embodiment of this application;

FIG. 4 shows a flowchart of a method for processing a clock skew according to an embodiment of this application;

FIG. 5 shows a schematic diagram of a process of uplink transmission among user equipment (UE), a 5G network element, and an application server (AS) according to an embodiment of this application;

FIG. 6 shows a schematic diagram of a process of downlink transmission among UE, a 5G network element, and an AS according to an embodiment of this application;

FIG. 7 shows a block diagram of an apparatus for processing a clock skew according to an embodiment of this application;

FIG. 8 shows a block diagram of an apparatus for processing a clock skew according to an embodiment of this application; and

FIG. 9 shows a schematic structural diagram of an electronic device suitable for implementing embodiments of this application.

### DESCRIPTION OF EMBODIMENTS

Exemplary implementations are now described in a more comprehensive manner with reference to the accompanying drawings. However, the exemplary implementations may be implemented in various forms, and are not to be understood as being limited to these examples. On the contrary, the purpose of providing these implementations is to make this application more comprehensive and complete, and to fully convey the concept of the exemplary implementations to a person skilled in the art.

In addition, the features, structures or characteristics described in this application can be combined in one or more embodiments in any appropriate manner. Plenty of specific details are offered in the following descriptions such that embodiments of this application can be fully understood. However, a person skilled in the art is to be aware that technical solutions of this application may be implemented without using all detailed features in the embodiments, one or more specific details may be omitted, or other methods, elements, apparatuses, and steps may be used.

The block diagrams shown in the accompanying drawings are merely functional entities and do not necessarily correspond to physically independent entities. That is, the functional entities may be implemented in a software form, in one or more hardware modules or integrated circuits, or in different networks and/or processor apparatuses and/or microcontroller apparatuses.

The flowcharts shown in the accompanying drawings are merely exemplary descriptions, do not certainly include all content and operations/steps, and are not certainly performed in the described sequences either. For example, some operations/steps may be further divided, while some operations/steps may be combined or partially combined. Thus, an actual performing sequence may change according to an actual situation.

The term “plurality of” mentioned herein refers to two or more. The term “and/or” describing an association relationship between associated objects denotes that there can be three relationships. For example, A and/or B can denote: A alone, both A and B, and B alone. The character “/” generally denotes an “or” relationship between the associated objects.

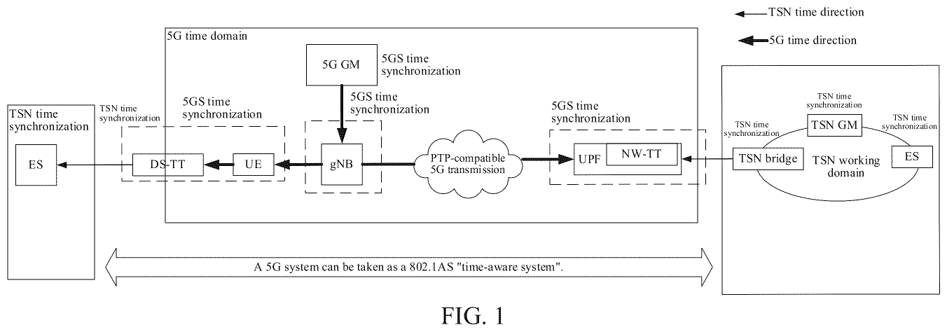

As technologies develop, time sensitive communication of a time sensitive network (TSN) is introduced to a 5th generation (5G) system such that the 5G system can support application of industrial automation manufacturing with precise time control. As shown in FIG. 1, in a system architecture in which a 5G system and a TSN are integrated, the 5G system is integrated into a TSN system as a TSN bridge. The “logic” TSN bridge includes a TSN translator, configured to perform a user plane interaction between the TSN system and the 5G system. A function of a 5G system (5GS) TSN translator includes a device side TSN translator (DS-TT) and a network TSN translator (NW-TT). User equipment (UE) in the 5G system is connected, by means of a DS-TT, to one or more end stations (ES, that is, a terminal station, which is a device connected to a local area network or a metropolitan area network to serve as a source and/or a destination of traffic carried on the local area network or the metropolitan area network) in a TSN data network (DN) outside the 5G system. A user plane function (UPF) is connected to one or more ESs in the TSN DN by using a NW-TT.

In order to implement a TSN synchronization mechanism, an entire end-to-end 5G system may be considered as an IEEE 802.1 AS time aware system. As shown in FIG. 1, two time synchronization fields exit and are a 5G time domain and a TSN time domain. The 5G system has its own time system (such as global positioning system (GPS) time system). In FIG. 1, a clock domain (that is, a 5G time domain) of the 5G system is represented by a 5G grand master (5G GM).

The next generation node B (gNB) in FIG. 1 represents a 5G base station. Each device in the 5G system is synchronized to the 5G clock domain. Each device in the 5G system includes: a UPF, a session management function (SMF), user equipment (UE), a DS-TT, a NW-TT, a next generation radio access network (NG RAN), etc. An NG interface is an interface between a radio access network and a 5G core network.

As shown in FIG. 1, a clock source of an external TSN time domain is located outside the UPF. A device ES on a UE side of a TSN is connected to UE by means of a DS-TT, connected to a 5G network, and then connected to an external TSN by means of a UPF and a NW-TT on the UPF, so as to perform time synchronization with a clock source of the TSN.

In FIG. 1, a time synchronization message is transmitted by a TSN GM by using downlink (DL) data, that is, transmitted by a user plane of UE. The downlink data including the time synchronization message of the TSN GM first reaches an NW-TT/UPF, enters the 5G system, then reaches the UE and its DS-TT, and finally reaches the ES on the UE side.

The TSN GM marks current time on an originTimestamp field of the time synchronization message transmitted by the TSN GM. When the user plane of the UE transfers the time synchronization message, the NW-TT marks, on the time synchronization message, receiving time when the NW-TT receives the downlink data, and updates a CorrectionField value in the data packet to an original CorrectionField value plus a transmission delay value between the NW-TT and an Ethernet bridge port that transmits the message to the NW-TT. Before forwarding the downlink data to the ES, the DS-TT subtracts, from current time, the receiving time added by the NW-TT to the downlink data, such that a transmission delay value of the time synchronization message in the entire 5G system is obtained. The delay value and previous transmission time (in a CorrectionField of the received time synchronization message) from the TSN grand master to the NW-TT are accumulated, such that an updated transmission delay value is obtained. The updated transmission delay value is marked on the CorrectionField (that is, a total transmission delay of the message) of the time synchronization message, and the previous receiving time marked by the NW-TT is deleted. Then, the amended time synchronization message is transmitted to the ES.

The ES directly adds, according to a delay value (that is, a CorrectionField value on the time synchronization message) marked by the DS-TT on the time synchronization message, the delay value of the time synchronization message to a transmission delay between the DS-TT and the ES. Thus, a total transmission delay of the time synchronization message from the TSN grand master to the ES can be obtained. A computation time value can be obtained by adding the total transmission delay to an originTimestamp field value on the time synchronization message. Then, a clock is set as the computation time value. Thus, time synchronization between the ES on the UE side and the TSN GM can be implemented.

In the above time synchronization process, a specific hardware device and network device, such as a TSN translator, are required to be added. As a result, hardware cost and implementation complexity will be undoubtedly increased. Such a requirement on hardware or a dedicated device limits actual deployment flexibility and raises cost. Based on this, a technical solution in an embodiment of this application provides a new method for processing a clock skew. The clock skew can be computed without increasing hardware cost. Thus, a requirement of low-cost clock synchronization can be satisfied.

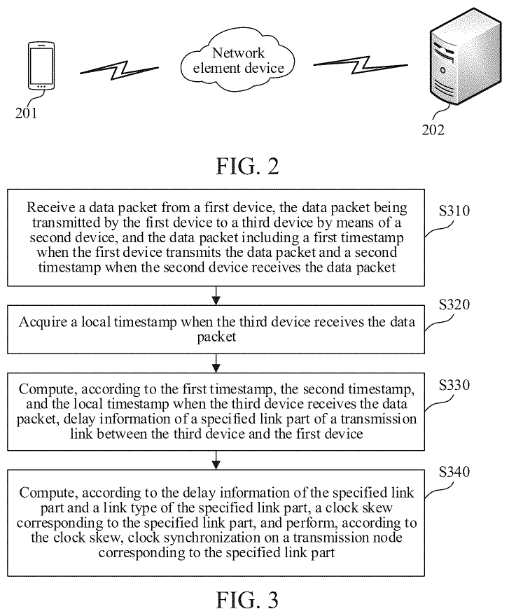

Specifically, in a system architecture shown in FIG. 2, a terminal device 201, a network element device of a mobile communication system, and an application server 202 are in communication connection to each other. The terminal device 201 transmits data to the application server 202 by means of the network element device of the mobile communication system. With an example in which the terminal device 201 transmits data to the application server 202, the terminal device 201 adds, to a data packet required to be transmitted, a first timestamp when the data packet is transmitted, and then transmits the data packet to the network element device. After receiving the data packet to which the first timestamp is added, the network element device adds, to the data packet, the second timestamp when the data packet is received, and then transmits the data packet to the application server 202.

When receiving the data packet, the application server 202 may acquire a local timestamp when the data packet is received, then may compute, according to the first timestamp, the second timestamp, and the local timestamp when the application server receives the data packet, delay information of a specified link part of a transmission link between the application server 202 and the terminal device 201, and further computes, according to the delay information of the specified link part and a link type of the specified link part, a clock skew corresponding to the specified link part.

For example, if the specified link part is a link between the terminal device 201 and the network element device, and the specified link part is an asymmetric link, a transmission delay of the data packet in the specified link part may be determined according to a difference between the second timestamp and the first timestamp. In order to compute the clock skew corresponding to the specified link part, a delay reference value of the specified link part may be inferred by measuring a transmission delay of the specified link part a plurality of times. Then, the clock skew corresponding to the specified link part is obtained by computing a difference between a transmission delay during each measurement and the delay reference value.

If the specified link part is a link between the terminal device 201 and the network element device, and the specified link part is a symmetric link, a transmission delay of the data packet in the specified link part may be determined according to a difference between the second timestamp and the first timestamp. Then, delay information when the data packet is transmitted from the network element device to the terminal device 201 is computed. Further, the clock skew corresponding to the specified link part is computed by using a transmission delay from the terminal device 201 to the network element device and delay information from the network device to the terminal device 201.

The terminal device 201 may be a smartphone, a tablet computer, a notebook computer, a desktop computer, a smart television, a smart home, an on board terminal, an aircraft, etc. The application server 202 may be an independent physical server, a server cluster or distributed system composed of a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The network element device may be a UPF or a protocol data unit (PDU) session anchor (PSA).

Implementation details of a technical solution of an embodiment of this application will be described in detail below.

FIG. 3 shows a flowchart of a method for processing a clock skew according to an embodiment of this application. The method for processing a clock skew is applied to a system including a first device, a second device, and a third device. The method for processing a clock skew may be performed by the third device or other devices having computing processing functions. As shown in FIG. 3, the method for processing a clock skew includes at least S310 to S340, which will be introduced in detail as follows:

S310: Receive a data packet from a first device. The data packet is transmitted by the first device to a third device by means of a second device. The data packet includes a first timestamp when the first device transmits the data packet and a second timestamp when the second device receives the data packet.

In some embodiments of this application, when transmitting data, the first device may add a local timestamp (that is, the first timestamp) to the data packet. When receiving the data packet, the second device adds, to the data packet, a local timestamp (that is, the second timestamp) when the data packet is received, and then transmits the data packet to the third device.

S320: Acquire a local timestamp when the third device receives the data packet.

In some embodiments of this application, since the second device transmits the data packet to the third device after adding the second timestamp to the data packet, a local timestamp of the third device may be acquired when the third device receives the data packet.

S330: Compute, according to the first timestamp, the second timestamp, and the local timestamp when the third device receives the data packet, delay information of a specified link part of a transmission link between the third device and the first device.

In some embodiments of this application, the specified link part represents a segment of the transmission link between the third device and the first device, such as: a link between the first device and the second device, a link between the second device and the third device, and a link between the first device and the third device.

In some embodiments of this application, the delay information of the specified link part may be computed by subtracting transmitting time of the data packet from receiving time of the data packet. For example, delay information of the transmission link between the first device and the second device may be obtained by subtracting the first timestamp from the second timestamp. Delay information of the transmission link between the second device and the third device may be obtained by subtracting the second timestamp from the local timestamp when the third device receives the data packet. Delay information of the transmission link between the first device and the third device may be obtained by subtracting the first timestamp from the local timestamp when the third device receives the data packet.

S340: Compute, according to the delay information of the specified link part and a link type of the specified link part, a clock skew corresponding to the specified link part, and perform, according to the clock skew, clock synchronization on a transmission node corresponding to the specified link part.

In some embodiments of this application, the link type of the specified link part may include an asymmetric link and a symmetric link. A symmetric link means that a communication link between two communication parties is symmetrical. That is, a communication link through which one party transmits data to the other party and a communication link through which the party receives data transmitted by the other party are the same. Alternatively, parameters such as a communication distance and a line length of the two communication links are the same such that delays in two data transmission directions (that is, a data transmitting direction and a data receiving direction) can be basically the same. An asymmetric link means that a path in which a node transmits data and a path in which the node receives data are inconsistent, such that delays in two data transmission directions (that is, a data transmitting direction and a data receiving direction) are different. Consequently, a communication link through which one party transmits data to the other party and a communication link through which the party receives data transmitted by the other party are asymmetric.

In some embodiments of this application, if the link type of the specified link part is an asymmetric link, a process of computing, according to the delay information of the specified link part and a link type of the specified link part, a clock skew corresponding to the specified link part may be as follows: According to statistics of delay information of the specified link part in different data transmission directions, the clock skew corresponding to the specified link part is computed.

Specifically, for example, delay reference information of the specified link part in a specified data transmission direction (such as an uplink transmission direction or a downlink transmission direction) may be obtained. The delay reference information is obtained by making statistics on historical delay information of the specified link part in the specified data transmission direction. Then, a first difference between delay information of the specified link part in the specified data transmission direction and the delay reference information in the specified data transmission direction is computed. The first difference is taken as a clock skew corresponding to the specified link part in the specified data transmission direction.

In some embodiments of this application, the delay reference information in the specified data transmission direction is inferred through an algorithm after historical delay information of the specified link part in the specified data transmission direction is acquired a plurality of times. For example, an average of historical delay information obtained a plurality of times is computed and taken as the delay reference information. Alternatively, the delay reference information may be inferred through machine learning according to historical delay information obtained a plurality of times.

In some embodiments of this application, in a case of an asymmetric link, the first device may be a terminal device, the second device may be a network element device of a mobile communication system, and the third device may be an application server. That is, the terminal device transmits a data packet to the application server by means of the network element device. In such an application scenario, the specified data transmission direction of the specified link part may include at least one of: a transmission link from the terminal device to the network element device, a transmission link from the network element device to the application server, and a transmission link from the terminal device to the application server.

In some embodiments of this application, in a case of an asymmetric link, the first device may be an application server, the second device may be a network element device of a mobile communication system, and the third device may be a terminal device. That is, the application server transmits a data packet to the terminal device by means of the network element device. In such an application scenario, the specified data transmission direction of the specified link part may include at least one of: a transmission link from the application server to the network element device, a transmission link from the network element device to the terminal device, and a transmission link from the application server to the terminal device.

In some embodiments of this application, if the link type of the specified link part is a symmetric link, a process of computing, according to the delay information of the specified link part and a link type of the specified link part, a clock skew corresponding to the specified link part may be as follows: Delay information of the specified link part during reverse data transmission is acquired. According to the delay information of the specified link part and the delay information of the specified link part during the reverse data transmission, the clock skew corresponding to the specified link part is computed.

In some embodiments of this application, a process of computing, according to the delay information of the specified link part and the delay information of the specified link part during the reverse data transmission, the clock skew corresponding to the specified link part may be as follows: A second difference between the delay information of the specified link part and the delay information of the specified link part during the reverse data transmission is computed. Then, half of the second difference is taken as the clock skew corresponding to the specified link part. Alternatively, perform corresponding compensation (such as an increase or a decrease) on the second difference, and take the second difference as the clock skew corresponding to the specified link part.

In some embodiments of this application, in a case of a symmetric link, one of the first device and the third device is a terminal device, and the other one is an application server. The second device may be a network element device of a mobile communication system. In such an application scenario, the specified link part includes at least one of: a transmission link between the terminal device and the network element device, a transmission link between the network element device and the application server, and a transmission link between the terminal device and the application server.

In some embodiments of this application, after the clock skew corresponding to the specified link part is computed, clock synchronization may be performed, according to the clock skew, on a transmission node corresponding to the specified link part. For example, if a clock skew between the first device and the second device is computed, clock synchronization may be performed, according to the clock skew between the first device and the second device, on the first device and the second device.

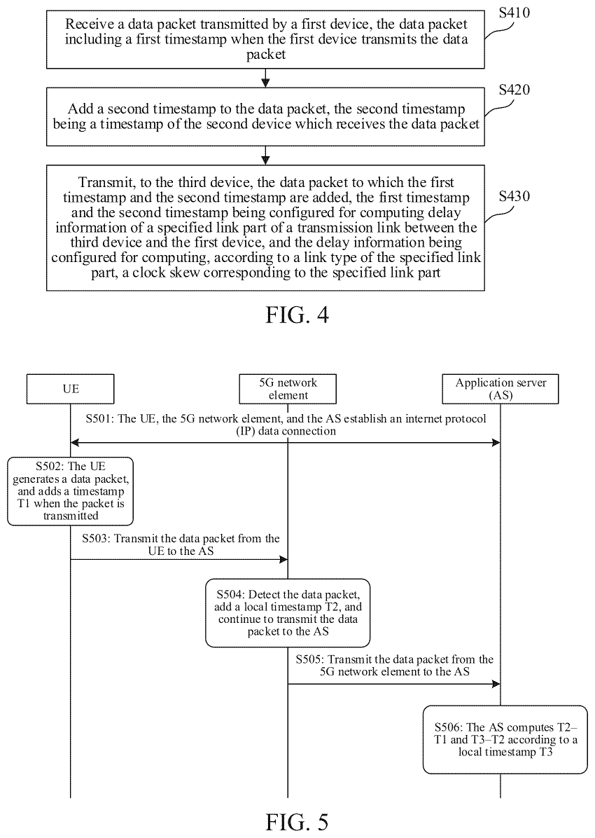

Implementation details of a technical solution in an embodiment of this application will be further described in detail below in combination with FIG. 4 from a point of view of a second device.

FIG. 4 shows a flowchart of a method for processing a clock skew according to an embodiment of this application. The method for processing a clock skew is applied to a system including a first device, a second device, and a third device. The method for processing a clock skew may be performed by the second device. As shown in FIG. 4, the method for processing a clock skew includes at least S410 to S430, which will be introduced in detail as follows:

S410: Receive a data packet transmitted by a first device. The data packet includes a first timestamp when the first device transmits the data packet.

In some embodiments of this application, when transmitting data, the first device may add a local timestamp (that is, the first timestamp) to a data packet, and then transmits the data packet to the second device.

S420: Add a second timestamp to the data packet. The second timestamp is a timestamp of the second device which receives the data packet.

In some embodiments of this application, when receiving the data packet transmitted by the first device, the second device may add a local timestamp (that is, the second timestamp) to the data packet, and then transmits the data packet to a third device.

S430: Transmit, to the third device, the data packet to which the first timestamp and the second timestamp are added. The first timestamp and the second timestamp are configured for computing delay information of a specified link part of a transmission link between the third device and the first device. The delay information is configured for computing, according to a link type of the specified link part, a clock skew corresponding to the specified link part.

In some embodiments of this application, processes of computing delay information of a specified link part of a transmission link between a third device and a first device, and computing, according to the delay information and a link type of the specified link part, a clock skew corresponding to the specified link part can be obtained with reference to the technical solutions of the above embodiments, and will not be repeated.

In some embodiments of this application, the second device may alternatively acquire a clock skew corresponding to the specified link part, and then perform clock synchronization according to the clock skew and a transmission node corresponding to the specified link part. For example, if a clock skew between the first device and the second device is computed, clock synchronization may be performed, according to the clock skew between the first device and the second device, on the first device and the second device.

In the technical solutions provided in the embodiments of this application, delay information of a specified link part of a transmission link between a third device and a first device is computed according to a first timestamp when the first device transmits a data packet, a second timestamp when a second device receives the data packet, and a local timestamp when the third device receives data. Then, a clock skew corresponding to the specified link part is computed according to the delay information of the specified link part and a link type of the specified link part. Thus, the clock skew can be estimated by using a time node in a transmission process of the data packet between the first device, the second device, and the third device. Further, the clock skew can be computed without increasing hardware cost, and a requirement of low-cost clock synchronization can be satisfied.

Implementation details of a technical solution of an embodiment of this application will be stated in detail below with a specific application scenario as an example in combination with FIG. 5 to FIG. 7.

In a specific application scenario, one node of UE (that is, a terminal device), a 5G network element, and an application server (AS) may be selected as a grand master node. Clocks of the other nodes are taken as slave clocks for time synchronization. In some embodiments, the 5G network element may be a UPF or a PSA.

In some embodiments, the UE and the AS record time information of data packet transmission by transmitting a data packet and inserting timestamp information into the data packet at different nodes, and determine a clock skew by computing a timestamp. In consideration of asymmetry of a cellular network, detection and statistics can be performed on an uplink and a downlink. For example, a computation process of an uplink (that is, a process that the UE transmits a data packet to the AS) may be set in the AS. A computation process of a downlink (that is, a process that the AS transmits a data packet to the UE) may be set in the UE.

As shown in FIG. 5, a process of uplink transmission among UE, a 5G network element, and an AS includes:

S501: The UE, the 5G network element, and the AS establish an internet protocol (IP) data connection.

S502: The UE generates a data packet, and adds a timestamp T1 when the packet is transmitted.

S503: Transmit the data packet from the UE to the AS.

S504: The 5G network element detects the data packet transmitted by the UE to the AS, adds a local timestamp T2 to the data packet, and continues to transmit the data packet to the AS.

S505: Transmit the data packet from the 5G network element to the AS.

S506: The AS computes delay information T2−T1 and T3−T2 according to a local timestamp T3 after receiving the data packet.

Specifically, T2−T1 represents a delay in an uplink direction in the 5G network. Moreover, T3−T2 represents a delay in an uplink direction between a 5G network gateway and the AS.

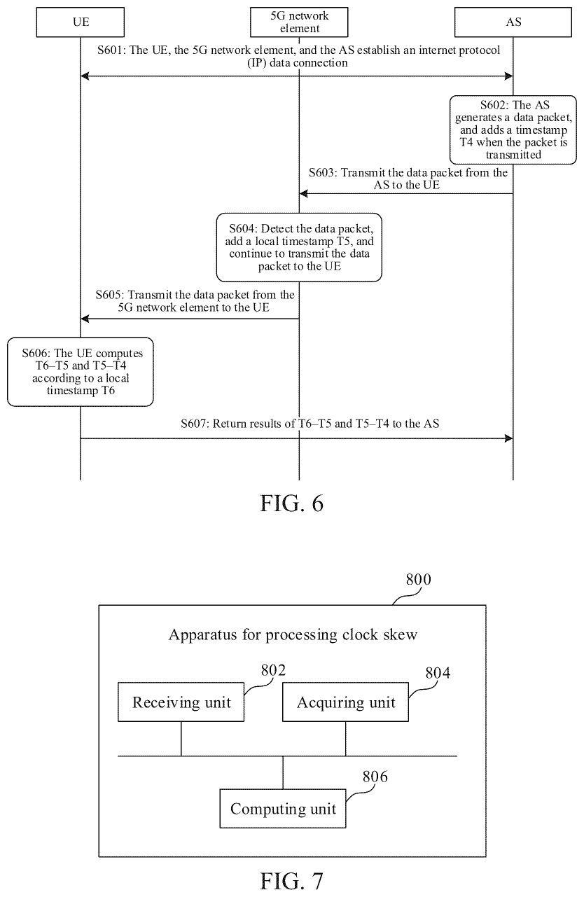

As shown in FIG. 6, a process of downlink transmission among UE, a 5G network element, and an AS includes:

S601: The UE, the 5G network element, and the AS establish an internet protocol (IP) data connection.

S602: The AS generates a data packet, and adds a timestamp T4 when the packet is transmitted.

S603: Transmit the data packet from the AS to the UE.

S604: The 5G network element detects the data packet transmitted by the AS to the UE, adds a local timestamp T5 to the data packet, and continues to transmit the data packet to the UE.

S605: Transmit the data packet from the 5G network element to the UE.

S606: The UE computes delay information T6−T5 and T5−T4 according to a local timestamp T6 after receiving the data packet.

Specifically, T5−T4 represents a delay in a downlink direction between the AS and a 5G network gateway. Moreover, T6−T5 represents a delay in a downlink direction in a 5G network.

S607: After computing delay information T6−T5 and T5−T4, the UE returns the delay information T6−T5 and T5−T4 to the AS such that the clock skew can be computed.

In some embodiments, based on the technical solutions of the embodiments shown in FIG. 5 and FIG. 6, when the clock skew is computed, an asymmetric link and a symmetric link may be distinguished from each other specifically as follows:

In a case of an asymmetric link,
delay information of a corresponding link may be collected a plurality of times in the foregoing manner. Then, a delay value of the link is obtained through a statistic analysis, etc. After the delay value (that is, the above delay reference information) of the link is obtained, a skew between the delay information obtained each time and the delay value may be computed and taken as the clock skew.

For example, in a case of a link between the UE and the 5G network element, delay information (that is, T2−T1) of a corresponding link is collected a plurality of times in the foregoing manner. Then, delay value Δt1 of the link is obtained through a statistic analysis, etc. Further, after the delay information T2−T1 of the link is detected each time, a skew between the delay information and the delay value Δt1 may be computed and taken as a clock skew of the link between the UE and the 5G network element.

Similarly, in a case of a link between the 5G network element and the AS, delay information (that is, T3−T2) of a corresponding link is collected a plurality of times in the foregoing manner. Then, delay value Δt2 of the link is obtained through a statistic analysis, etc. Further, after the delay information T3−T2 of the link is detected each time, a skew between the delay information and the delay value Δt2 may be computed and taken as a clock skew of the link between the 5G network element and the AS.

In a case of a link between the UE and the AS, delay information (that is, T3−T1) of a corresponding link is collected a plurality of times in the foregoing manner. Then, delay value Δt3 of the link is obtained through a statistic analysis, etc. Further, after the delay information T3−T1 of the link is detected each time, a skew between the delay information and the delay value Δt3 may be computed and taken as a clock skew of the link between the UE and the AS.

In a case of a link between the AS and the 5G network element, delay information (that is, T5−T4) of a corresponding link is collected a plurality of times in the foregoing manner. Then, delay value Δt4 of the link is obtained through a statistic analysis, etc. Further, after the delay information T5−T4 of the link is detected each time, a skew between the delay information and the delay value Δt4 may be computed and taken as a clock skew of the link between the AS and the 5G network element.

In a case of a link between the 5G network element and the UE, delay information (that is, T6−T5) of a corresponding link is collected a plurality of times in the foregoing manner. Then, delay value Δt5 of the link is obtained through a statistic analysis, etc. Further, after the delay information T6−T5 of the link is detected each time, a skew between the delay information and the delay value Δt5 may be computed and taken as a clock skew of the link between the 5G network element and the UE.

In a case of a link between the AS and the UE, delay information (that is, T6−T4) of a corresponding link is collected a plurality of times in the foregoing manner. Then, delay value Δt6 of the link is obtained through a statistic analysis, etc. Further, after the delay information T6−T4 of the link is detected each time, a skew between the delay information and the delay value Δt6 may be computed and taken as a clock skew of the link between the AS and the UE.

In a case of a symmetric link,
assuming that a communication link between an end A and an end B is a symmetric link, a local timestamp when the end A transmits a data packet 1 is t1, and a local timestamp when the end B receives the data packet 1 is t2. A local timestamp when the end B transmits a data packet 2 is t3, and a local timestamp when the end A receives the data packet 2 is t4. Assuming that a clock skew between the end A and the end B is x, a local timestamp when the end B theoretically receives the data packet 1 is t2′=t2+x, and a local timestamp when the end B theoretically transmits the data packet 2 is t3′=t3+x.

Considering that a link between the end A and the end B is a symmetric link, t2′−t1=t4−t3′. By substituting t2′=t2+x and t3′=t3+x, t2−t1+x=t4−t3−x, and further, x=1/2 [(t4−t3)−(t2−t1)].

Accordingly, in combination with FIG. 5 and FIG. 6, a clock skew between the UE and the 5G network element is estimated as 1/2[(T6−T5)−(T2−T1)]. A clock skew between the UE and the AS is estimated as 1/2[(T6−T4)−(T3−T1)]. A clock skew between the 5G network element and the AS is estimated as 1/2[(T5−T4)−(T3−T2)].

The technical solutions of the above embodiments of this application perform estimation based on time point information in a transmission process of a data packet among a terminal, a network, and an application server, instead of relying on a dedicated hardware device for clock synchronization measurement. The solution can implement synchronization among UE, a network, and a server without relying on TSN dedicated hardware and network device, and satisfies a requirement (such as a requirement of a millimeter-level light-weight and low-cost synchronization solution in a scenario such as intelligent traffic) of low-cost clock synchronization.

An apparatus embodiment of this application will be introduced below, and may be configured to perform the method for processing a clock skew in the above embodiments of this application. Details not disclosed in the apparatus embodiment of this application can be obtained with reference to the above embodiments of the method for processing a clock skew of this application.

FIG. 7 shows a block diagram of an apparatus for processing a clock skew according to an embodiment of this application. The apparatus for processing a clock skew is applied to a system including a first device, a second device, and a third device. The apparatus for processing a clock skew may be arranged in the third device or other devices having computing processing functions.

With reference to FIG. 7, the apparatus 800 for processing a clock skew according to an embodiment of this application includes: a receiving unit 802, an acquiring unit 804, and a computing unit 806.

The receiving unit 802 is configured to receive a data packet from a first device. The data packet is transmitted by the first device to a third device by means of a second device. The data packet includes a first timestamp when the first device transmits the data packet and a second timestamp when the second device receives the data packet. The acquiring unit 804 is configured to acquire a local timestamp when the third device receives the data packet. The computing unit 806 is configured to compute, according to the first timestamp, the second timestamp, and the local timestamp, delay information of a specified link part of a transmission link between the third device and the first device, and compute, according to the delay information of the specified link part and a link type of the specified link part, a clock skew corresponding to the specified link part.

In some embodiments of this application, based on the above solutions, the link type includes an asymmetric link. The computing unit 806 is configured to compute, according to the delay information of the specified link part and a link type of the specified link part, a clock skew corresponding to the specified link part as follows:
compute, if the link type of the specified link part is an asymmetric link, according to statistics of delay information of the specified link part in different data transmission directions, the clock skew corresponding to the specified link part.

In some embodiments of this application, based on the above solution, the computing unit 806 computes, according to statistics of delay information of the specified link part in different data transmission directions, the clock skew corresponding to the specified link part as follows: acquire delay reference information of the specified link part in a specified data transmission direction, the delay reference information being obtained by making statistics on historical delay information of the specified link part in the specified data transmission direction; and
compute a first difference between delay information of the specified link part in the specified data transmission direction and the delay reference information in the specified data transmission direction, and take the first difference as a clock skew corresponding to the specified link part in the specified data transmission direction.

In some embodiments of this application, based on the above solution, the first device includes a terminal device, the second device includes a network element device of a mobile communication system, and the third device includes an application server. The specified data transmission direction of the specified link part includes at least one of: a transmission link from the terminal device to the network element device, a transmission link from the network element device to the application server, and a transmission link from the terminal device to the application server.

In some embodiments of this application, based on the above solution, the first device includes an application server, the second device includes a network element device of a mobile communication system, and the third device includes a terminal device. The specified data transmission direction of the specified link part includes at least one of: a transmission link from the application server to the network element device, a transmission link from the network element device to the terminal device, and a transmission link from the application server to the terminal device.

In some embodiments of this application, based on the above solutions, the link type includes a symmetric link. The computing unit 806 is configured to compute, according to the delay information of the specified link part and a link type of the specified link part, a clock skew corresponding to the specified link part as follows: acquire, if the link type of the specified link part is a symmetric link, delay information of the specified link part during reverse data transmission; and compute, according to the delay information of the specified link part and the delay information of the specified link part during the reverse data transmission, the clock skew corresponding to the specified link part.

In some embodiments of this application, based on the above solution, the computing unit 806 computes, according to the delay information of the specified link part and the delay information of the specified link part during the reverse data transmission, the clock skew corresponding to the specified link part as follows:
compute a second difference between the delay information of the specified link part and the delay information of the specified link part during the reverse data transmission; and
take half of the second difference as the clock skew corresponding to the specified link part.

In some embodiments of this application, based on the above solution, one of the first device and the third device is a terminal device, and the other one is an application server. The second device includes a network element device of a mobile communication system. The specified link part includes at least one of: a transmission link between the terminal device and the network element device, a transmission link between the network element device and the application server, and a transmission link between the terminal device and the application server.

In some embodiments of this application, based on the above solution, the apparatus 800 for processing a clock skew further includes: a processing unit configured to perform, after the clock skew corresponding to the specified link part is computed, according to the clock skew, clock synchronization on a transmission node corresponding to the specified link part.

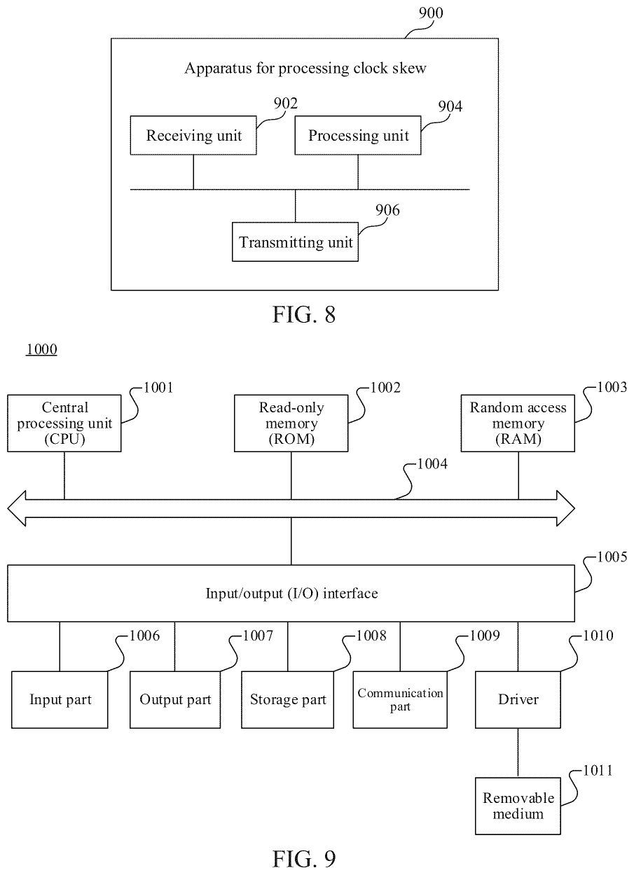

FIG. 8 shows a block diagram of an apparatus for processing a clock skew according to an embodiment of this application. The apparatus for processing a clock skew is applied to a system including a first device, a second device, and a third device. The apparatus for processing a clock skew may be arranged in the second device.

With reference to FIG. 8, the apparatus 900 for processing a clock skew according to an embodiment of this application includes: a receiving unit 902, a processing unit 904, and a transmitting unit 906.

The receiving unit 902 is configured to receive a data packet transmitted by a first device. The data packet includes a first timestamp when the first device transmits the data packet. The processing unit 904 is configured to add a second timestamp to the data packet. The second timestamp is a timestamp of the second device which receives the data packet. The transmitting unit 906 is configured to transmit, to a third device, the data packet to which the first timestamp and the second timestamp are added. The first timestamp and the second timestamp are configured for computing delay information of a specified link part of a transmission link between the third device and the first device. The delay information is configured for computing, according to a link type of the specified link part, a clock skew corresponding to the specified link part.

In some embodiments of this application, based on the above solution, the processing unit 904 is further configured to: acquire the clock skew corresponding to the specified link part; and perform clock synchronization according to the clock skew and a transmission node corresponding to the specified link part.

FIG. 9 is a schematic structural diagram of a computer system suitable for implementing an electronic device according to an embodiment of this application.

The computer system 1000 of the electronic device shown in FIG. 9 is merely an example, and is not to constitute any limitation to functions and use ranges of embodiments of this application.

As shown in FIG. 9, the computer system 1000 includes a central processing unit (CPU) 1001, which may perform various suitable actions and processing according to a program stored in a read-only memory (ROM) 1002 or a program loaded from a storage part 1008 into a random access memory (RAM) 1003, for example, perform the method described in the above embodiments. Various programs and data required for system operations are further stored in the RAM 1003. The CPU 1001, the ROM 1002, and the RAM 1003 are connected to each other by a bus 1004. An input/output (I/O) interface 1005 is further connected to the bus 1004.

The following components are connected to the I/O interface 1005: an input part 1006 including a keyboard, a mouse, etc.; an output part 1007 including a cathode ray tube (CRT), a liquid crystal display (LCD), a speaker, etc.; the storage part 1008 including a hard disk, etc.; and a communication part 1009 including a network interface card such as a local area network (LAN) card and a modem. The communication part 1009 performs communication by means of a network such as the Internet. A driver 1010 is further connected to the I/O interface 1005 according to requirements. A removable medium 1011, such as a magnetic disk, an optical disc, a magneto-optical disk, or a semiconductor memory, is installed on the driver 1010 according to requirements such that a computer program read from the removable medium can be installed into the storage part 1008 according to requirements.

Particularly, according to embodiments of this application, the processes described above with reference to flowcharts may be implemented as computer software programs. For example, an embodiment of this application includes a computer program product. The computer program product includes a computer program stored in a computer-readable medium. The computer program includes a computer program for performing a method shown in a flowchart. In such an embodiment, the computer program may be downloaded and installed from a network by the communication part 1009, and/or installed from the removable medium 1011. When executed by the CPU 1001, the computer program performs various functions defined in the system of this application.

The computer-readable medium shown in an embodiment of this application may be a computer-readable signal medium, a computer-readable storage medium, or any combination of the foregoing. The computer-readable storage medium may be but is not limited to an electric, magnetic, optical, electromagnetic, infrared, or semi-conductive system, apparatus, or device, and any combination of the foregoing for example. A more specific example of the computer-readable storage medium may include but is not limited to: an electrical connection having one or more wires, a portable computer disk, a hard disk, a random access memory (RAM), a read-only memory (ROM), an erasable programmable read only memory (EPROM), a flash memory, an optical fiber, a portable compact disk read-only memory (CD-ROM), an optical storage device, a magnetic storage device, or any suitable combinations of the foregoing. In this application, the computer-readable storage medium may be any tangible medium including or storing a program. The program may be used by or used in combination with an instruction execution system, apparatus, or device. In this application, the computer-readable signal medium may include a data signal transmitted in a baseband or as a part of a carrier, and stores a computer-readable computer program. A data signal propagated in such a way may assume a plurality of forms, including but not limited to an electromagnetic signal, an optical signal, and any appropriate combinations of the foregoing. The computer-readable signal medium may be any computer-readable medium in addition to a computer-readable storage medium. The computer-readable medium may transmit, propagate, or transfer a program that is used by or used in combination with an instruction execution system, apparatus, or device. The computer program included in the computer-readable medium may be transmitted by means of any suitable medium, including but not limited to: a wireless medium, a wired medium, and any suitable combinations of the foregoing.

The flowcharts and block diagrams in the accompanying drawings illustrate possible system architectures, functions and operations that may be implemented by a system, a method, and a computer program product according to various embodiments of this application. Each block in a flowchart or a block diagram may represent a module, a program segment, or a part of code. The module, the program segment, or the part of code includes one or more executable instructions for implementing specified logic functions. In some implementations taken as substitutes, functions annotated in blocks may alternatively occur in a sequence different from that annotated in figures. For example, two blocks shown in succession may be actually performed basically in parallel, and sometimes may be performed in a reverse sequence, which is determined by an involved function. Each block in the flowcharts and/or the block diagrams and combinations of the blocks in the flowcharts and/or the block diagrams may be implemented by a dedicated hardware-based system that perform a specified function or operation, or may be implemented by a combination of dedicated hardware and computer program.

An involved unit described in embodiments of this application may be implemented in a software manner or in a hardware manner, and can be alternatively arranged in a processor. Names of these units do not constitute a limitation to the units in a specific situation.

As another aspect, this application further provides a non-transitory computer-readable medium. The computer-readable medium may be included in the electronic device described in the above embodiments, or may exist alone without being assembled into the electronic device. The above computer-readable medium carries one or more computer programs. When executed by an electronic device, the one or more computer programs cause the electronic device to implement the methods described in the above embodiments.

Although several modules or units of a device for performing actions are mentioned in the above detailed descriptions, such division is not compulsory. Actually, according to implementations of this application, features and functions of two or more modules or units described above may be embodied in one module or unit. On the contrary, features and functions of one module or unit described above may be further divided to be embodied by a plurality of modules or units.

According to the descriptions of the above implementations, a person skilled in the art may readily understand that the exemplary implementations described herein may be implemented by means of software, or may be implemented by combining software and necessary hardware. Thus, technical solutions according to the implementations of this application may be implemented in a form of a software product. The software product may be stored in a non-volatile storage medium (which may be a CD-ROM, a USB flash drive, a removable hard disk, etc.) or on a network, which includes several instructions to cause a computing device (which may be a personal computer, a server, a touch terminal, a network device, etc.) to perform the method according to the implementations of this application.

After considering the specification and practicing the implementations disclosed herein, a person skilled in the art may easily conceive of other implementation solutions of this application. This application is intended to cover any variations, uses, or adaptive changes of this application. These variations, uses, or adaptive changes follow the general principles of this application and include common general knowledge or customary technical means in the art that are not disclosed in this application.

This application is not limited to the precise structures described above and shown in the accompanying drawings. Moreover, various modifications and changes can be made without departing from the scope of this application. The scope of this application is limited by the appended claims.

What is claimed is:

1. A method for processing a clock skew performed by an electronic device, the method comprising:
receiving a data packet, wherein the data packet is transmitted via a transmission link from a first device to a second device and then from the second device to the electronic device, and the data packet comprising a first timestamp and a second timestamp, wherein the first timestamp is added into the data packet when the first device transmits the data packet, and the second timestamp is added into the data packet when the second device receives the data packet;
acquiring a local timestamp when the electronic device receives the data packet;
acquiring, according to the first timestamp, the second timestamp, and the local timestamp, delay information of a specified link part of the transmission link between the electronic device and the first device;
acquiring, according to the delay information of the specified link part and a link type of the specified link part, a clock skew corresponding to the specified link part; and
performing, according to the clock skew, clock synchronization on a transmission node corresponding to the specified link part.

2. The method according to claim 1, wherein the computing, according to the delay information of the specified link part and a link type of the specified link part, a clock skew corresponding to the specified link part comprises:
when the link type of the specified link part is an asymmetric link, computing the clock skew corresponding to the specified link part according to statistics of delay information of the specified link part in different data transmission directions.

3. The method according to claim 2, wherein the computing clock skew corresponding to the specified link part according to statistics of delay information of the specified link part in different data transmission directions comprises:
acquiring delay reference information of the specified link part in a specified data transmission direction based on statistics on historical delay information of the specified link part in the specified data transmission direction; and
computing a first difference between delay information of the specified link part in the specified data transmission direction and the delay reference information in the specified data transmission direction as the clock skew corresponding to the specified link part in the specified data transmission direction.

4. The method according to claim 3, wherein the first device comprises a terminal device, the second device comprises a network element device of a mobile communication system, and the electronic device comprises an application server; and
the specified data transmission direction of the specified link part comprises at least one of: a transmission link from the terminal device to the network element device, a transmission link from the network element device to the application server, and a transmission link from the terminal device to the application server.

5. The method according to claim 3, wherein the first device comprises an application server, the second device comprises a network element device of a mobile communication system, and the electronic device comprises a terminal device; and
the specified data transmission direction of the specified link part comprises at least one of: a transmission link from the application server to the network element device, a transmission link from the network element device to the terminal device, and a transmission link from the application server to the terminal device.

6. The method according to claim 1, wherein the computing, according to the delay information of the specified link part and a link type of the specified link part, a clock skew corresponding to the specified link part comprises:
when the link type of the specified link part is a symmetric link, acquiring second delay information of the specified link part during reverse data transmission; and
computing, according to the delay information of the specified link part and the second delay information of the specified link part during the reverse data transmission, the clock skew corresponding to the specified link part.

7. The method according to claim 6, wherein the computing, according to the delay information of the specified link part and the second delay information of the specified link part during the reverse data transmission, the clock skew corresponding to the specified link part comprises:
computing a second difference between the delay information of the specified link part and the second delay information of the specified link part during the reverse data transmission; and
taking half of the second difference as the clock skew corresponding to the specified link part.

8. The method according to claim 6, wherein one of the first device and the electronic device is a terminal device, and the other one is an application server; the second device comprises a network element device of a mobile communication system; and
the specified link part comprises at least one of: a transmission link between the terminal device and the network element device, a transmission link between the network element device and the application server, and a transmission link between the terminal device and the application server.

9. An electronic device, comprising:
one or more processors; and
a memory configured to store one or more computer programs, the one or more computer programs, when executed by the one or more processors, causing the electronic device to implement a method for processing a clock skew including:
receiving a data packet, wherein the data packet is transmitted via a transmission link from a first device to a second device and then from the second device to the electronic device, and the data packet comprising a first timestamp and a second timestamp, wherein the first timestamp is added into the data packet when the first device transmits the data packet, and the second timestamp is added into the data packet when the second device receives the data packet;
acquiring a local timestamp when the electronic device receives the data packet;
acquiring, according to the first timestamp, the second timestamp, and the local timestamp, delay information of a specified link part of the transmission link between the electronic device and the first device;
acquiring, according to the delay information of the specified link part and a link type of the specified link part, a clock skew corresponding to the specified link part; and
performing, according to the clock skew, clock synchronization on a transmission node corresponding to the specified link part.

10. The electronic device according to claim 9, wherein the computing, according to the delay information of the specified link part and a link type of the specified link part, a clock skew corresponding to the specified link part comprises:
when the link type of the specified link part is an asymmetric link, computing the clock skew corresponding to the specified link part according to statistics of delay information of the specified link part in different data transmission directions.

11. The electronic device according to claim 10, wherein the computing clock skew corresponding to the specified link part according to statistics of delay information of the specified link part in different data transmission directions comprises:
acquiring delay reference information of the specified link part in a specified data transmission direction based on statistics on historical delay information of the specified link part in the specified data transmission direction; and
computing a first difference between delay information of the specified link part in the specified data transmission direction and the delay reference information in the specified data transmission direction as the clock skew corresponding to the specified link part in the specified data transmission direction.

12. The electronic device according to claim 11, wherein the first device comprises a terminal device, the second device comprises a network element device of a mobile communication system, and the electronic device comprises an application server; and
the specified data transmission direction of the specified link part comprises at least one of: a transmission link from the terminal device to the network element device, a transmission link from the network element device to the application server, and a transmission link from the terminal device to the application server.

13. The electronic device according to claim 11, wherein the first device comprises an application server, the second device comprises a network element device of a mobile communication system, and the electronic device comprises a terminal device; and
the specified data transmission direction of the specified link part comprises at least one of: a transmission link from the application server to the network element device, a transmission link from the network element device to the terminal device, and a transmission link from the application server to the terminal device.

14. The electronic device according to claim 9, wherein the computing, according to the delay information of the specified link part and a link type of the specified link part, a clock skew corresponding to the specified link part comprises:
when the link type of the specified link part is a symmetric link, acquiring second delay information of the specified link part during reverse data transmission; and
computing, according to the delay information of the specified link part and the second delay information of the specified link part during the reverse data transmission, the clock skew corresponding to the specified link part.

15. The electronic device according to claim 14, wherein the computing, according to the delay information of the specified link part and the second delay information of the specified link part during the reverse data transmission, the clock skew corresponding to the specified link part comprises:
computing a second difference between the delay information of the specified link part and the second delay information of the specified link part during the reverse data transmission; and
taking half of the second difference as the clock skew corresponding to the specified link part.

16. The electronic device according to claim 14, wherein one of the first device and the electronic device is a terminal device, and the other one is an application server; the second device comprises a network element device of a mobile communication system; and
the specified link part comprises at least one of: a transmission link between the terminal device and the network element device, a transmission link between the network element device and the application server, and a transmission link between the terminal device and the application server.

17. A non-transitory computer-readable medium, having one or more computer programs stored therein, the one or more computer programs, when executed by one or more processors of an electronic device, causing the electronic device to implement a method for processing a clock skew including:
receiving a data packet, wherein the data packet is transmitted via a transmission link from a first device to a second device and then from the second device to the electronic device, and the data packet comprising a first timestamp and a second timestamp, wherein the first timestamp is added into the data packet when the first device transmits the data packet, and the second timestamp is added into the data packet when the second device receives the data packet;
acquiring a local timestamp when the electronic device receives the data packet;
acquiring, according to the first timestamp, the second timestamp, and the local timestamp, delay information of a specified link part of the transmission link between the electronic device and the first device;
acquiring, according to the delay information of the specified link part and a link type of the specified link part, a clock skew corresponding to the specified link part; and
performing, according to the clock skew, clock synchronization on a transmission node corresponding to the specified link part.

18. The non-transitory computer-readable medium according to claim 17, wherein the computing, according to the delay information of the specified link part and a link type of the specified link part, a clock skew corresponding to the specified link part comprises:
when the link type of the specified link part is an asymmetric link, computing the clock skew corresponding to the specified link part according to statistics of delay information of the specified link part in different data transmission directions.

19. The non-transitory computer-readable medium according to claim 18, wherein the computing clock skew corresponding to the specified link part according to statistics of delay information of the specified link part in different data transmission directions comprises:
acquiring delay reference information of the specified link part in a specified data transmission direction based on statistics on historical delay information of the specified link part in the specified data transmission direction; and
computing a first difference between delay information of the specified link part in the specified data transmission direction and the delay reference information in the specified data transmission direction as the clock skew corresponding to the specified link part in the specified data transmission direction.

20. The non-transitory computer-readable medium according to claim 17, wherein the computing, according to the delay information of the specified link part and a link type of the specified link part, a clock skew corresponding to the specified link part comprises:
when the link type of the specified link part is a symmetric link, acquiring second delay information of the specified link part during reverse data transmission; and
computing, according to the delay information of the specified link part and the second delay information of the specified link part during the reverse data transmission, the clock skew corresponding to the specified link part.
